(19) United States
(12) Patent Application Publication
(10) Pub. No.: US 2003/0145005 A1
(43) Pub. Date: Jul. 31, 2003

(54) Method and system for facilitating use of the global positioning system (GPS)

(76) Inventors: Timothy P. Blair, Boise, ID (US); Roger T. Baird, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/056,698

(22) Filed: Jan. 25, 2002

(51) Int. Cl. G06F 7/00

(52) U.S. Cl. 707/10

(57) ABSTRACT

Methods for facilitating use of the global positioning system (GPS) by obtaining the GPS coordinates that correspond to a location and providing the coordinates to GPS device are disclosed. An illustrative method includes the steps of coupling a client device to a network and to a GPS device, using the client device to access a database through the network, the database containing the GPS coordinates that correspond to a plurality of locations, obtaining from the database the GPS coordinates corresponding to at least one location, and providing the GPS coordinates corresponding to the at least one location to the GPS device. Illustrative methods are implemented via the web and via e-mail. Systems and computer-readable media also are provided.

### BACKGROUND OF THE INVENTION

1. Field of the Invention

The invention relates generally to the use of the global positioning system (GPS), and, more particularly, to a method and system for facilitating use of the GPS by obtaining the GPS coordinates that correspond to a location and providing the coordinates to a GPS device.

2. Related Art

In recent years, the global positioning system (GPS) has enabled users to determine their location anywhere in the world with a precision that was previously unattainable. Although the GPS was developed and is currently maintained by the United States Department of Defense (DOD), it is available to both military and civilian users. The GPS consists of 24 operational satellites in six circular orbits that are spaced so that a minimum of 4 satellites are in view to users anywhere in the world at any given time. Using triangulation techniques, a user with a GPS device may determine his or her precise location in three-dimensions: latitude, longitude, and altitude. Additionally, the GPS system provides the current time, and by making more than one measurement and keeping track of the exact time of the measurements, the GPS device can calculate velocity.

The user of a GPS device can also use the device to determine the direction and distance from his or her current location to a destination location, provided that the GPS coordinates of the destination location are known. To accomplish this, a user typically uses the device to determine his or her location. Then, the user typically enters the coordinates of a destination location into the device. After the GPS coordinates of the destination are provided to the GPS device, the GPS device uses the coordinates of the user's present location and the coordinates of the destination location to provide the user with the direction and distance from the user's current location to the destination.

If the user has traveled to a destination previously, he or she may have used the GPS device to obtain the coordinates of the location at that time. If the user saved the coordinates of the location during his or her previous visit, the coordinates may be stored in the GPS device. The coordinates can then be used by the GPS device to determine the direction and distance to the destination from any starting point, which can be determined from the GPS by the GPS device. While this process enables a user to travel to a previously visited location from a different starting point, it is often desirable to travel to a destination that has not been visited previously.

In order to obtain the direction and distance to a destination not previously visited, the user must obtain the coordinates of the destination. Unfortunately, the utility of current GPS devices for providing the direction and distance to a given destination location is typically limited by the fact that the GPS coordinates for most locations are not readily available or accessible.

Therefore, there is a need for a method and system that overcome the deficiencies and inadequacies stated above.

### SUMMARY

A method and system for facilitating use of the global positioning system (GPS) by obtaining the GPS coordinates that correspond to a location, such as a street address, and providing those coordinates to a GPS device are disclosed. The method includes the steps of coupling a client device to a network and to a GPS device; using the client device to access a database through the network, the database containing the GPS coordinates that correspond to a plurality of locations; obtaining from the database the GPS coordinates corresponding to at least one location; and providing the GPS coordinates corresponding to the at least one location to the GPS device.

The system includes a client device coupled to a network and to a GPS device; a database coupled to the network through a server device, the database containing the GPS coordinates that correspond to a plurality of locations, wherein the client device obtains from the database the GPS coordinates that correspond to a location and provides the coordinates to the GPS device.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating the overall system environment in which the method and system for facilitating use of the global positioning system (GPS) by obtaining the GPS coordinates that correspond to a location and providing the coordinates to a GPS device resides.

FIG. 2 is a block diagram illustrating an exemplar client device of FIG. 1.

FIG. 3 is a block diagram illustrating an exemplar environment in which embodiments of the invention reside.

FIG. 4 is a flowchart illustrating the operation of particular embodiments of the invention in the exemplar environment of FIG. 3 from the point of view of a user of the client device of FIG. 3.

FIG. 5 is a flowchart illustrating the operation of particular embodiments of the invention in the exemplar environment of FIG. 3 from the point of view of the server device of FIG. 3.

FIG. 6 is a block diagram illustrating an exemplar environment in which embodiments of the invention reside.

FIG. 7 is a flowchart illustrating the operation of particular embodiments of the invention in the exemplar environment of FIG. 6 from the point of view of a user of the client device of FIG. 6.

FIG. 8 is a flowchart illustrating the operation of particular embodiments of the invention in the exemplar environment of FIG. 6 from the point of view of the server device of FIG. 6.

### DETAILED DESCRIPTION OF THE INVENTION

The method and system for facilitating use of the global positioning system (GPS) can be implemented in software (e.g., firmware), hardware, or a combination thereof. In one embodiment, the method and system for facilitating use of the GPS are implemented in a configuration in which a plurality of devices are coupled to a network and the user of the system uses a computer, such as a personal computer (PC) to access the connected devices, and in which the method and system are implemented using primarily software. Regardless of the manner of implementation, the software portion of the invention can be executed by a special or general-purpose computer, such as a personal computer (PC; IBM-compatible, Apple-compatible, or otherwise), workstation, minicomputer, or mainframe computer. Various other types of computing devices, including such computing devices as personal digital assistants (PDAs) and cellular telephones having computing capabilities, may be used to execute the software portion of the invention.

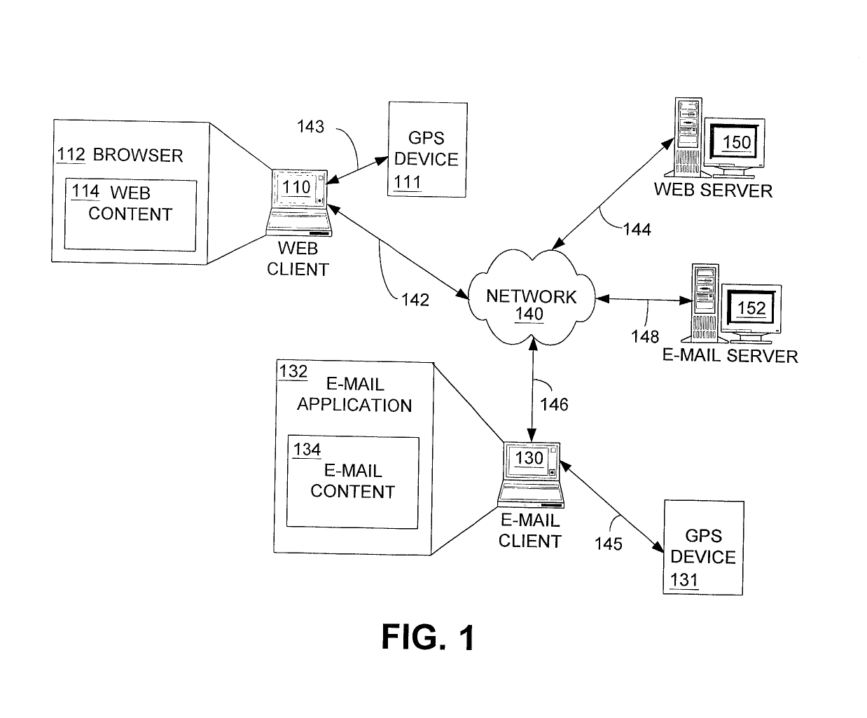

Prior to discussing particular aspects of embodiments of the invention, a brief description of the overall system and environment in which the invention resides is provided. In this regard, FIG. 1 is a block diagram illustrating an exemplar system environment in which the method and system for facilitating use of the global positioning system (GPS) by obtaining a set of GPS coordinates that correspond to a location and providing the coordinates to a GPS device may reside.

FIG. 1 illustrates a client-server environment including a web client device 110 and an e-mail client device 130. The web client device 110 and the e-mail client device 130 are both coupled to a network 140. A web server 150 and an e-mail server 152 are also coupled to the network 140. The web client device 110 is coupled to the network 140 via connection 142 and the e-mail client device 130 is coupled to the network 140 via connection 146. Similarly, the web server 150 is coupled to the network 140 via connection 144 and the e-mail server 152 is coupled to the network 140 via connection 148. Although the web client device 110 and the e-mail client device 130 are shown illustratively as separate devices, the web and e-mail client functions described below may be executed by a single device. Likewise, although the web server 150 and e-mail server 152 are shown illustratively as separate devices, the web and e-mail client functions described below may be executed by a single device.

The web client device 110 is coupled to a GPS device 111 via connection 143. The e-mail client device 130 is coupled to a GPS device 131 via connection 145. Alternatively, the web client device 110 and the e-mail client device 130 can be coupled to their respective GPS units 111 and 131 through the network 140. In addition, although the web client device 110 and the GPS device 111 are shown illustratively as separate devices, the web client device 110 and the GPS device 111 alternatively may be combined in a single device. Likewise, although the e-mail client device 130 and the GPS device 131 are shown illustratively as separate devices, the e-mail client device 130 and the GPS device 131 alternatively may be combined in a single device.

The network 140 can be any network used to couple devices and can be, for example, a LAN or a WAN. In the example to follow, the network 140 is illustratively a wide area network such as the WWW portion of the Internet. Furthermore, the connections 142, 143, 144, 145, 146 and 148 can be any known connections that can couple electronic devices to each other or to the Internet, such as direct electrical and/or optical connections, wireless connections, dial-up modem style connections, digital subscriber line (DSL) connections, cable modem connections, and/or T1 or other high speed backbone communication lines.

The web client device 110 can be, for example but not limited to, a personal computer (PC), such as a laptop computer as illustrated in FIG. 1. Similarly, the email client device 130 can be a PC or a laptop. Various other types of computing devices, including such computing devices as personal digital assistants (PDAs) and cellular telephones having computing capabilities, may be used as the client devices.

The web client device 110 includes a web browser 112 which receives. processes and displays web content 114. The web content 114 refers to hypertext markup language (HTML) documents and related information (as described in more detail below) that are received from other devices over the network 140, such as the web server 150, via the hypertext transfer protocol (HTTP). Essentially, the web content 114 is code that includes, for example, hypertext mark-up language (HTML) commands that generate images, forms, etc., and includes graphics and code such as JAVAScript and Java applets.

The GPS devices 111 and 131 may be any commercially available or custom built devices that are capable of receiving GPS satellite signals and computing their own location based on such signals, and determining the direction and distance from their current location to another location based on the GPS coordinates of the other location.

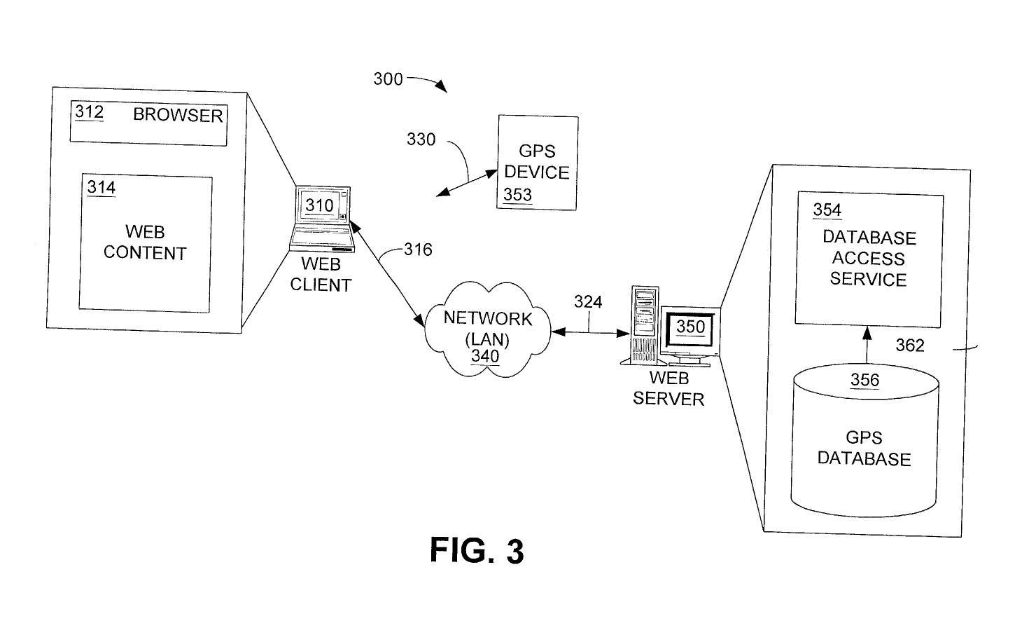

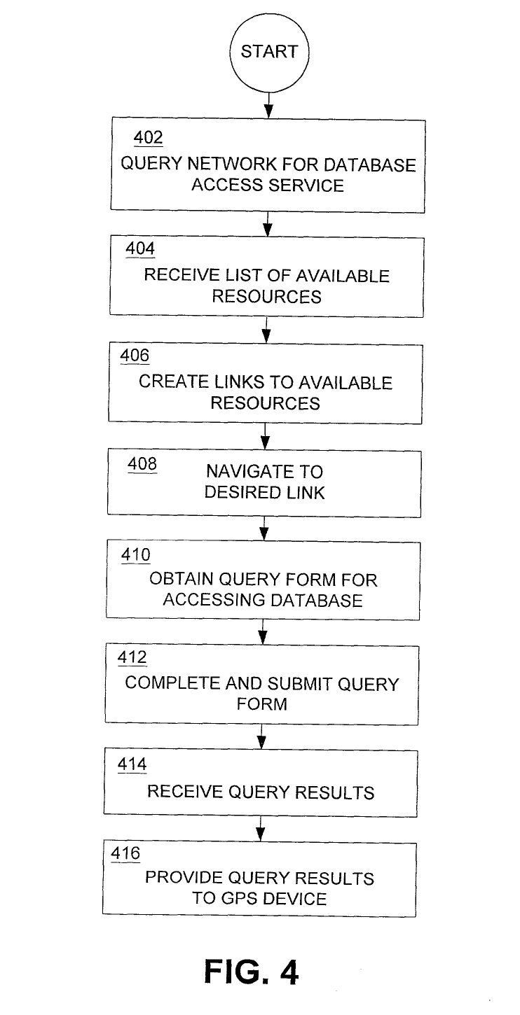

A brief description of the operation of the system shown in FIG. 1 may be helpful in understanding the operation of particular aspects of the invention to be described below with respect to FIGS. 3, 4A and 4B. Assume that an individual using the web client device 110 points the browser 112 to a particular web site located on the first server 150. In such an instance, the browser 112 requests content from the web server 150, which content is delivered to the web client device 110 and stored as web content 114. The web content 114 may, illustratively, include a particular home page that is presented to the user of the web client device 110.

Similarly, the e-mail client device 130 includes e-mail application 132, which receives, processes and displays e-mail content 134. The e-mail content 134 refers to text messages and computer files that are received from other devices over the network 140, such as the e-mail server 152, via the simple mail transfer protocol (SMTP).

The operation of the e-mail client device 130 is similar to that described above for the web client device 110. Assume that an individual using the e-mail client device 130 uses the e-mail software to access an e-mail application 132 through the second server 152. In such an instance, the e-mail application 132 requests content from the e-mail server 152, which content is delivered to the e-mail client device 130 and stored as e-mail content 134. The e-mail content 134 may, illustratively, include a particular e-mail application that is presented to the user of the e-mail client device 130.

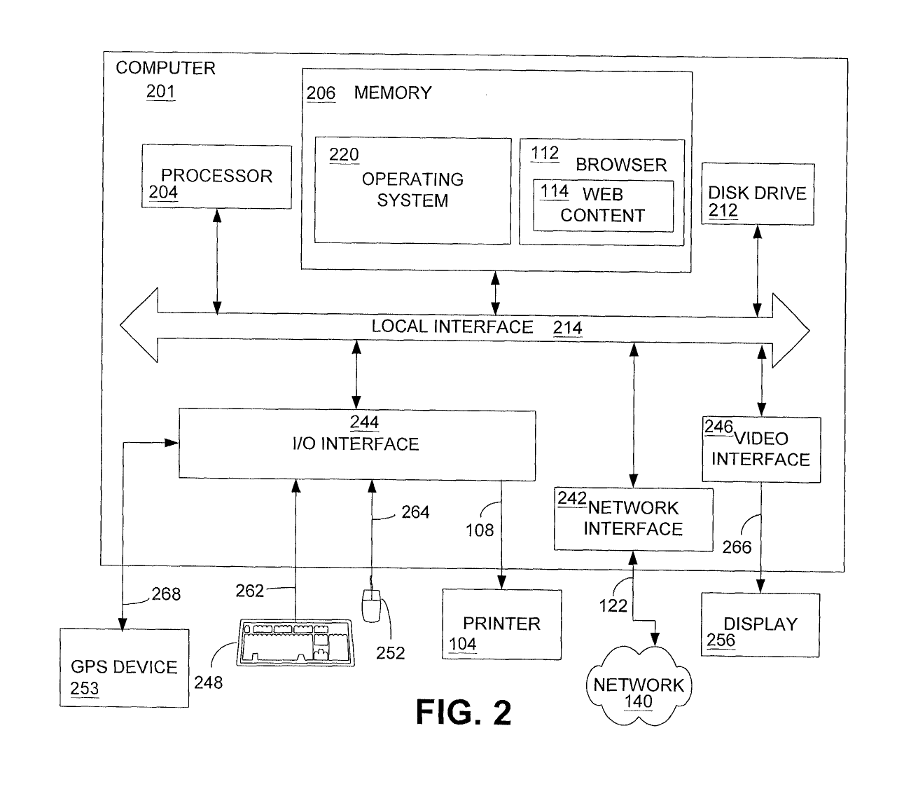

An example of a general-purpose computer that can implement the software of the invention is shown in FIG. 2. FIG. 2 is a block diagram illustrating an exemplar computer 201 that can be used as the web client device 110 or the e-mail client device 130 of FIG. 1. The web client device 110 can obtain the global positioning system (GPS) coordinates that correspond to an address through web server 150. The web client device 110 can then provide the coordinates to GPS device 111. The web content 114 and other software and hardware elements (to be discussed with respect to FIG. 2) work in unison to implement the functionality of the invention. Likewise, the e-mail client device 130 can obtain the global positioning system (GPS) coordinates that correspond to an address through e-mail server 152. The e-mail client device 130 can then provide the coordinates to GPS device 131. The web content 114, e-mail content 134 and other software and hardware elements (to be discussed with respect to FIG. 2) work in unison to implement the functionality of the invention.

Generally, in terms of hardware architecture, as shown in FIG. 2, an exemplar computer 201 which can be used as web client device 110 or e-mail client device 130 includes a processor 204, memory 206, a disk drive 212, an I/O interface 244, a video interface 246, and a network interface 242 that are connected together and can communicate with each other via a local interface 214. The local interface 214 can be, for example but not limited to, one or more buses or other wired or wireless connections, as is known to those having ordinary skill in the art. The local interface 214 may have additional elements, which are omitted for simplicity, such as buffers (caches), drivers, and controllers, to enable communications. Further, the local interface 214 includes address, control, and data connections to enable appropriate communications among the aforementioned components.

The processor 204 is a hardware device for executing software that can be stored in memory 206. The processor 204 can be any custom made or commercially available processor, a central processing unit (CPU) or an auxiliary processor among several processors associated with the computer 201, and a microchip-based microprocessor or a macroprocessor. Examples of suitable commercially available microprocessors are as follows: a PA-RISC series microprocessor from Hewlett-Packard Company, an 80×86 or Pentium series microprocessor from Intel Corporation, a PowerPC microprocessor from IBM Corporation, a Sparc microprocessor from Sun Microsystems, Inc., or a 68xxx series microprocessor from Motorola Corporation.

The memory 206 can include any one or combination of volatile memory elements (e.g., random access memory (RAM, such as DRAM, SRAM, etc.)) and nonvolatile memory elements (e.g., RAM, ROM, hard drive, tape, CDROM, etc.). Moreover, the memory 206 may incorporate electronic, magnetic, optical, and/or other types of storage media. Note that the memory 206 can have a distributed architecture, where various components are situated remote from one another, but can be accessed by the processor 204.

The I/O interface 244 can receive commands from, for example, keyboard 248 via connection 262 and from mouse 252 via connection 264 and transfer those commands over the local interface 214 to the processor 204 and the memory 206. The I/O interface 244 also sends printer commands to the printer 104 via connection 108, and sends and receives signals to and from GPS device 253 via connection 268. Although the GPS device 253 is shown in FIG. 2 as being separate from and external to the computer 201, the GPS device 253 and the computer alternatively may be combined in a single device.

The video interface 246 supplies a video output signal via connection 266 to the display 256. The display 256 can be a conventional CRT based display device, or can be any other display device, such as a liquid crystal display (LCD) or other type of display. The network interface 242 can be any communication device capable of connecting the computer 201 to an external network 140, such as a network interface card located in the computer 201 or a modulator/demodulator (modem).

The software in memory 206 may include one or more separate programs, each of which comprises an ordered listing of executable instructions for implementing logical functions. In the example illustrated in FIG. 2, the software in the memory 206 includes the software required to run the browser 112 and process the web content 114 of the web client device 110 of FIG. 1. If the exemplar computer 201 of FIG. 2 were configured as the e-mail client device 130 instead of the web client device 110 (an alternative configuration not shown in FIG. 2), the memory 206 would include the software required to run the e-mail application 132 and process the e-mail content 134 of the e-mail client device 130 in lieu of the browser 112 and web content 114 software. If the exemplar computer 201 of FIG. 2 were configured as both the web client device 110 and the e-mail client device 130 (another alternative configuration not shown in FIG. 2), the memory 206 would include the software required to run the browser 112 and process the web content 114 of the web client device 110 and the software required to run the e-mail application 132 and process the e-mail content 134 of the e-mail client device 130.

In any of these alternative configurations, the memory 206 also includes a suitable operating system (O/S) 220. With respect to the operating system 220, a non-exhaustive list of examples of suitable commercially available operating systems 220 is as follows: a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 220 essentially controls the execution of other computer programs, such as the browser 112 and/or email application 132, and provides scheduling, input-output control, file and data management, memory management, and communication control and related services. The processor 204 and operating system 220 define a computer platform, for which application programs, such as the browser 112 and/or e-mail application 132, are written in higher level programming language(s).

If the computer 201 is a PC, the software in the memory 206 further includes a basic input output system (BIOS) (omitted for simplicity). The BIOS is a set of essential software routines that test hardware at startup, start the O/S 220, and support the transfer of data among the hardware devices. The BIOS is stored in ROM so that it can be executed when the computer 201 is activated.

When the computer 201 is in operation, the processor 204 is configured to execute software stored within the memory 206, to communicate data to and from the memory 206 and to generally control operations of the computer 201 pursuant to the software. In the example illustrated in FIG. 2, the browser 112, portions of the web content 114 and the O/S 220, in whole or in part, but typically the latter, are read by the processor 204, perhaps buffered within the processor 204, and then executed.

When the method and system for obtaining the global positioning system (GPS) coordinates that correspond to a location and providing the coordinates to a GPS device are implemented primarily in software, as is shown in FIG. 2, it should be noted that the browser 112 and web content 114, and the e-mail application 132 and email content 134, can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The browser 112 and web content 114, and the e-mail application 132 and e-mail content 134, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The hardware components of the invention can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 3 is a block diagram illustrating an exemplar processing environment in which embodiments of the invention reside. The processing environment 300 includes a web client computer 310 coupled via connection 316 to a network 340 and via connection 330 to a GPS device 353. Alternatively, the GPS device 353 could be incorporated into web client computer 310. The connections 316 and 330 can be conventional, modem-type wired connections or can be wireless connections. The network 340 can be a LAN or a WAN, and for illustrative purposes only, is a LAN in this example. Typically, many such client computers will be coupled to the network 340. The processing environment 300 also includes a web server computer 350 coupled to the network 340 via connection 324.

The web client computer 310 includes a browser 312 which receives, processes and displays web content 314. The web client computer 310 may independently browse to and communicate with any element connected to the network 340 that includes a web server. The web content 314 refers to information that is received from other computers over the network 340, such as the web server computer 350.

The web server computer 350 includes a database access service 354 coupled to a GPS database 356 through connection 362. The GPS database 356, while shown as residing within the web server 350, may be remotely located from the web server 350 and accessible via the network 340. Essentially, the database access service 354 is a set of URL's that refer to any database(s) accessible through the web server 350, including but not limited to GPS database 356.

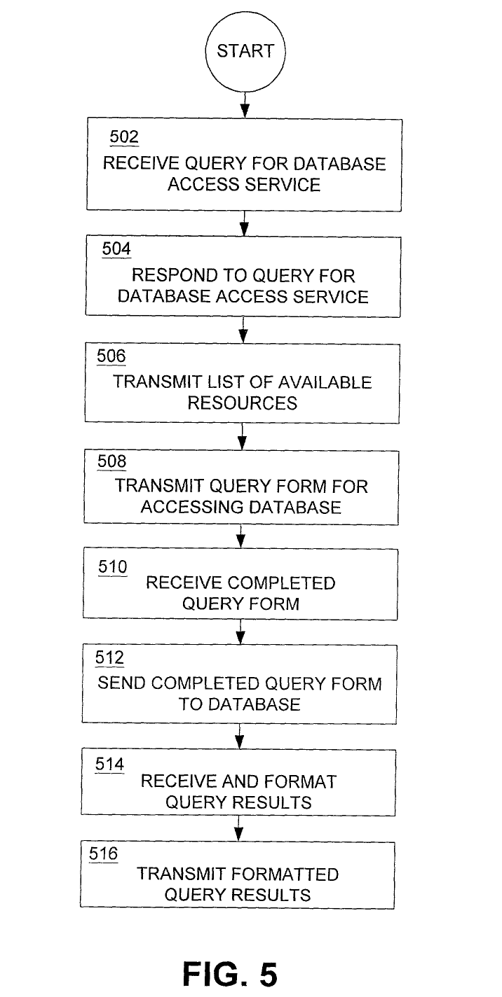

FIGS. 4 and 5 are flowcharts which collectively illustrate the operation of particular embodiments of the invention by which the user of web client computer 310 can access information from GPS database 356 and provide that information to GPS device 353. The flowchart of FIG. 4 illustrates the embodiment from the standpoint of a user of web client computer 310. The flowchart of FIG. 5 is complimentary to the flowchart of FIG. 4, and illustrates the embodiment from the standpoint of the web server computer 350.

With reference to FIG. 4, in block 402, a user of the web client computer 310 uses browser 312 to query the network 340 to detect the presence of a database access service 354. This may be accomplished by, for example, the browser 312 using the service location protocol (SLP) to broadcast a packet over the network 340 asking for a particular type of service, in this example a database access service such as that provided by the database access service 354. The operation of SLP is known to those having ordinary skill in the art. This query occurs over the network 340.

In block 404, the web client computer 310 receives a list of available resources from the database access service 354, such as by receiving a home page associated with the database access service 354. The list of available resources is essentially a set of URL's that correspond to the databases that can be accessed from the web client computer 310 through database access service 354, including but not limited to GPS database 356.

In block 406, the browser 312, using the information received from the database access service 354, creates a link to each available resource and makes these inks available to the user of the web client computer 310 as part of web content 314 as, for example, hyperlinks.

In block 408, the user of web client computer 310 navigates to the desired link within web content 314. In this example, the user will use the desired link to access GPS database 356. In block 410, the user of web client computer 310 obtains from the GPS database 356, through web server computer 350, an appropriate query form for accessing the database 356, such as an HTML query form, which is displayed to the user of web client computer 310 by the browser 312 as part of the web content 314.

In block 412, the user of web client computer 310 submits the location for which GPS coordinates are desired to the web server computer 350 by entering the required parameters on the query form, such as the address for which the GPS coordinates are sought, and transmitting the completed query form back to the web server computer 350. The web server computer 350 then sends the user's query to the GPS database 356. This may be done by formulating a structured query language (SQL) query corresponding to the user's query and sending the SQL query to the GPS database 356.

In block 414, the web client computer 310 receives the properly formatted query results (i.e., the GPS coordinates for the submitted location) from the GPS database 356 via the web server computer 350 over network 340. Finally, in block 416, the query results (GPS coordinates) are provided to the GPS device 353. This can be accomplished by displaying the GPS coordinates to the user of web client computer 310 and the user manually inputting the GPS coordinates into the GPS device 353. Alternatively, the web client computer 310 can automatically provide the GPS coordinates to the GPS device 353 via connection 330. In another embodiment (not shown) in which the client computer is connected to the GPS device through a network, the GPS coordinates can be provided to the GPS device through the network.

With reference to FIG. 5, in block 502, the server computer 350 receives a query to detect the presence of a database access service 354 from a user of the web client computer 310 through browser 312. This may be accomplished by, for example, receiving an SLP packet broadcast over the network 340 from browser 312 asking for a particular type of service, in this example a database access service such as that provided by the database access service 354. If there is a database access service 354 available, it will respond with its identity in block 504. The operation of SLP is known to those having ordinary skill in the art. This query and response occurs over the network 340.

In block 506, the database access service 354, through server computer 350, transmits a list of available resources to the web client computer 310, such as by providing a home page associated with the database access service 354 to the web client computer 310. The list of available resources is essentially a set of URL's that correspond to the databases that can be accessed from the web client computer 310 through database access service 354, including but not limited to GPS database 356.

In block 508, the GPS database 356, through web server computer 350, transmits to the user of web client computer 310 an appropriate query form for accessing the database 356 to obtain the GPS coordinates for a specific location, such as an HTML query form, which is displayed to the user of web client computer 310 by the browser 312 as part of the web content 314.

In block 510, the web server computer 350 receives the completed query form from the user of client computer 310 over network 340. In block 512, the web server computer 350 sends the user's query to the GPS database 356. This may be done by formulating a structured query language (SQL) query corresponding to the user's query and sending the SQL query to the GPS database 356.

In block 514, the web server computer 350 receives the query results from the GPS database 356 and formats the query results for return to the user of web client computer 310. This may involve reformatting a SQL response into an appropriate HTML format for transmission from the web server computer 350 to the web client computer 310 over network 340. Finally, in step 516, the web server computer 350 transmits the properly formatted query results to the web client computer 310 over network 340.

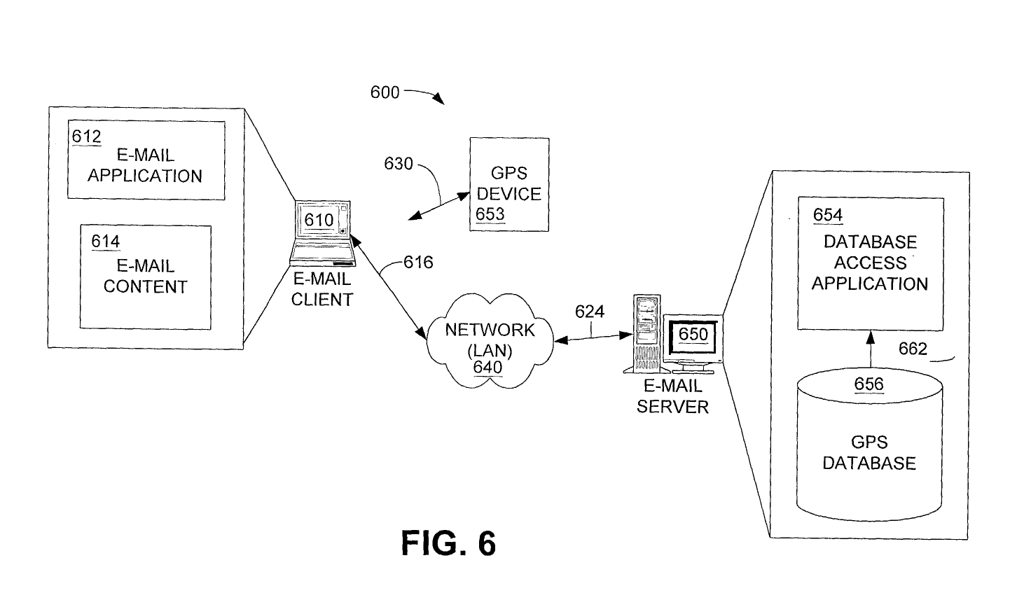

FIG. 6 is a block diagram illustrating another exemplar processing environment in which embodiments of the invention reside. The processing environment 600 includes an e-mail client computer 610 coupled via connection 616 to a network 640 and via connection 630 to a GPS device 653. Alternatively, the GPS device 653 may be incorporated into e-mail client computer 610. The connections 616 and 630 can be conventional, modem-type wired connections or can be wireless connections. The network 640 can be a LAN or a WAN, and for illustrative purposes only, is a LAN in this example. Typically, many such client computers will be coupled to the network 640. The processing environment 600 also includes an e-mail server computer 650 coupled to the network 640 via connection 624.

The e-mail client computer 610 includes e-mail application 612 which receives, processes and displays e-mail content 614. The e-mail client computer 610 may independently access and communicate with any element connected to the network 640 that includes an e-mail server. The e-mail content 614 refers to information that is received from other computers over the network 640, such as the e-mail server computer 650.

The e-mail server computer 650 includes a database access application 654 coupled to a GPS database 656 through connection 662. The GPS database 656, while shown as residing within the e-mail server computer 650, may be remotely located from the e-mail server computer 650 and accessible via the network 640. Essentially, the database access application 654 is a set of e-mail addresses that refer to any database(s) accessible through the e-mail server computer 650, including but not limited to GPS database 656.

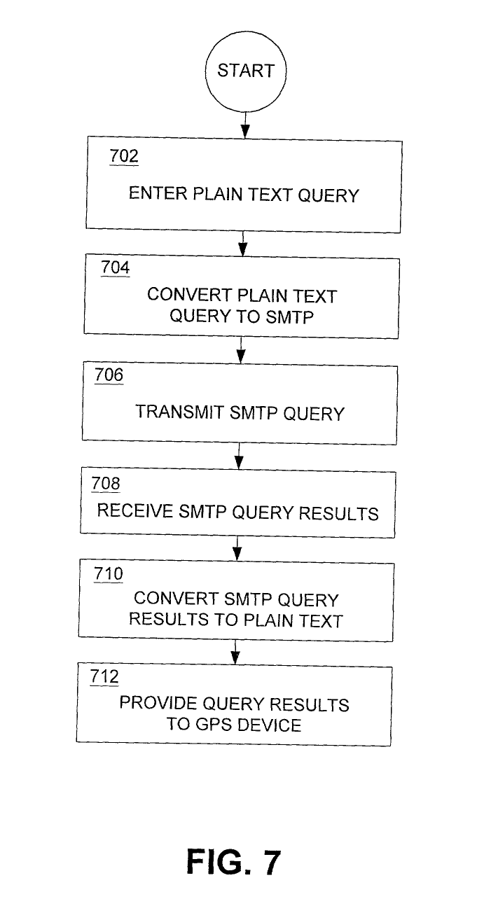

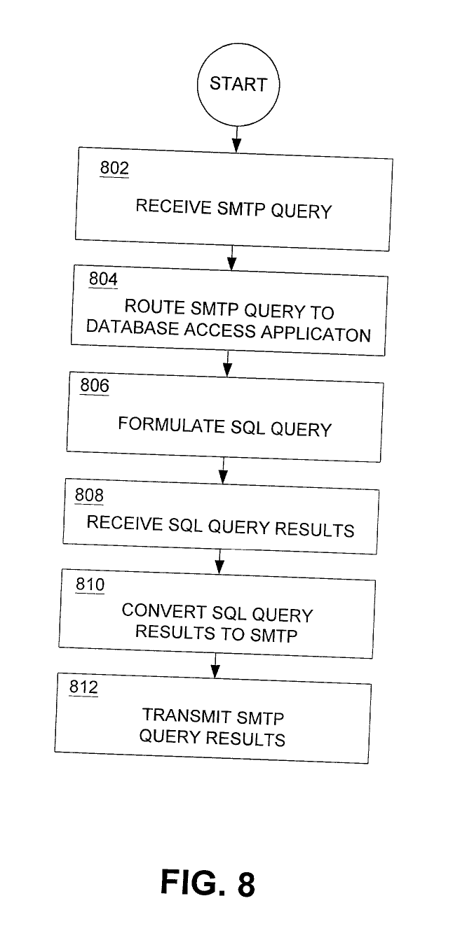

FIGS. 7 and 8 are flowcharts which collectively illustrate the operation of particular embodiments of the invention by which the user of e-mail client computer 610 can access information from GPS database 656. The flowchart of FIG. 7 illustrates the embodiment from the standpoint of a user of e-mail client computer 610. The flowchart of FIG. 8 is complimentary to the flowchart of FIG. 7, and illustrates the embodiment from the standpoint of the e-mail server computer 650.

With reference to FIG. 7, in block 702, a user of the e-mail client computer 610 enters a plain text e-mail query seeking the GPS coordinates for a specific location, such as an address. In block 704, the e-mail application 612 converts the plain text query into the simple mail transfer protocol (SMTP), and in block 706 the email client computer 610 transmits the SMTP query to the e-mail server computer 650 over network 640 in block 706. In block 708, the e-mail client computer 610 receives the results of the query in SMTP format from the e-mail server computer 650 over network 640. In block 710, the e-mail client computer 610 routes the SMTP formatted query results to the e-mail application 612, where the SMTP results are converted into plain text query results. Finally, in block 712, the plain text query results are provided to the GPS device 653. This can be accomplished by displaying the GPS coordinates to the user of e-mail client computer 610 and the user manually inputting the GPS coordinates into the GPS device 653. Alternatively, the e-mail client computer 610 can automatically provide the GPS coordinates to the GPS device 653 via connection 630. In another embodiment (not shown) in which the client computer is connected to the GPS device through a network, the GPS coordinates can be provided to the GPS device through the network.

With reference to FIG. 8, in block 802, the e-mail server computer 650 receives a SMTP query from the e-mail client computer 610 via the network 640. In block 804, the e-mail server computer 650 routes the SMTP query to the database access application 654. In block 806, the database access application 654 formulates a structured query language (SQL) query corresponding to the SMTP query and sends the SQL query to the GPS database 656.

In block 808, the database access application 654 receives the query results from the GPS database 656 in SQL format. In block 810, the database application 654 converts the SQL query results into the SMTP format. Finally, in block 812, the e-mail server computer 650 transmits the SMTP formatted query results to the e-mail client computer 610 over network 640.

It will be apparent to those skilled in the art that many modifications and variations may be made to the preferred embodiments of the present invention, as set forth above, without departing substantially from the principles of the present invention. For example, a user of a client device in a central location, such as the dispatcher for a delivery company, may obtain the GPS coordinates for all pending deliveries over the Internet and provide the coordinates for each location to the delivery driver assigned to make the delivery to that location. Each delivery driver can then use the coordinates in a GPS device to map his or her delivery route. Alternatively, the dispatcher could obtain the coordinates and download them automatically into the appropriate driver's GPS device. A traveler having a cellular telephone with e-mail capability could obtain the GPS coordinates for a particular destination through an e-mail query and use those coordinates in a GPS device to find his or her destination. All such modifications and variations are intended to be included herein within the scope of the present invention, as defined in the claims that follow.

1. A method for facilitating use of the global positioning system (GPS) the method comprising the steps of:
coupling a client device to a network and to a GPS device;
using the client device to access a database through the network, the database containing the GPS coordinates that correspond to a plurality of locations;
obtaining from the database the GPS coordinates corresponding to at least one location; and
providing the GPS coordinates corresponding to the at least one location to the GPS device.

2. The method of claim 1, wherein the step of providing the GPS coordinates to the GPS device is performed automatically.

3. The method of claim 1, wherein the network is the Internet.

4. The method of claim 1, wherein the step of accessing a database comprises the steps of:
accessing a predefined web page through the client device, the predefined web page being coupled to the database; and
accessing the database through the predefined web page.

5. The method of claim 4, wherein the step of accessing a predefined web page comprises the steps of:
browsing to a particular location on the web through the client device;
receiving in the client device a web page associated with the location, the web page including a link to the database; and
displaying the web page associated with the location on a display associated with the client device.

6. The method of claim 1, wherein the step of accessing a database comprises the steps of:
accessing an e-mail application through the client device, the e-mail application being coupled to the database; and
accessing the database through the e-mail application.

7. The method of claim 6, wherein the step of accessing an e-mail application comprises the steps of:
establishing communication between the client device and an e-mail server; and
accessing the e-mail application through the e-mail server.

8. A system for facilitating use of the global positioning system (GPS), comprising:
a client device coupled to a network and to a GPS device;
a database coupled to the network through a server device, the database containing the GPS coordinates that correspond to a plurality of locations; and
wherein the client device obtains from the database the GPS coordinates that correspond to a location and provides the coordinates to the GPS device.

9. The system of claim 8, wherein the GPS coordinates obtained from the database are provided to the GPS device automatically.

10. The system of claim 8, wherein the GPS device is part of the client device.

11. The system of claim 8, wherein the GPS device is located remotely from the client device.

12. The system of claim 8, wherein the client device is a personal computer (PC).

13. The system of claim 8, wherein the client device is a personal digital assistant (PDA).

14. The system of claim 8, wherein the client device is a cellular telephone.

15. A computer readable medium for facilitating use of the global positioning system (GPS), comprising:
logic configured to couple a client device to a network and to a GPS device, to use the client device to access a database through the network, the database containing the GPS coordinates that correspond to a plurality of locations, to obtain from the database the GPS coordinates corresponding to at least one location, and to provide the GPS coordinates corresponding to at least one location to the GPS device.

16. The computer readable medium of claim 15, wherein the GPS coordinates corresponding to the at least one location are provided to the GPS device automatically.

17. The computer readable medium of claim 16, wherein the network is the Internet.

18. The computer readable medium of claim 17, wherein the database is accessed by accessing a predefined web page that is coupled to the database.

19. The computer readable medium of claim 18, wherein the predefined web page is accessed by:
logic in the client device configured to browse to a particular location on the web, to receive a web page associated with the location, the web page including a link to the database, and to display the web page associated with the location on a display associated with the client device.

20. The computer readable medium of claim 15, wherein the database is accessed by accessing an e-mail application that is coupled to the database.
